(19) United States
(12) Patent Application Publication
(10) Pub. No.: US 2003/0051162 A1
(43) Pub. Date: Mar. 13, 2003

(54) Data line interrupter switch

(76) Inventor: Christopher Kirchmann, Coqutlarn (CA)

Correspondence Address: Hall Priddy Myers & Vande Sande, 200 10220 River Road, Potomac, MD, 20854, US

(21) Appl. No.: 10/049,099

(22) PCT Filed: Jun. 8, 2001
(86) PCT No.: PCT/CA01/00850

(30) Foreign Application Priority Data
Jun. 9, 2000 (CA) 2310538

(51) Int. Cl. H04L 9/00

(52) U.S. Cl. 713/201

(57) ABSTRACT

The invention is a data interruption device which is comprised of an input port, an output port and a connection therebetween. The data interruption device provides for two states, one where the connection between the input port and output port is open, and the other where the connection is closed. A switch provides for the transition between the two states. The device also includes an external mechanism, preferably a push button, to activate the switch. The switch may also be controlled from a computer, if desired.

### FIELD

The invention relates to a hardware device for interrupting an otherwise continuous data line, for example, a computer network connection.

### BACKGROUND

Computer network security, particularly in relation to the Internet, is an issue of growing concern. Corporate and personal users face the risk of theft or destruction of data, commonly known as “hacking”, from outside sources. This problem is augmented by the increased use of high-speed, uninterrupted Internet connections such as DSL/ADSL and cable modems.

Currently, most computer security devices are provided as software. The most common types of software security are anti-virus software and “firewall” software. Anti-virus software is designed prevent and remove “virus” programs that can be transmitted through email and Internet connections. Firewalls are designed to act as a barrier between a computer or computer network and a connection to the Internet. Firewalls work by preventing access to the computer or computer network from the Internet without meeting certain security requirements (set by the user).

The existing security devices suffer from the problem that they are implemented in software. As a result, the software itself is susceptible to hacking and may be rendered ineffective. In extreme cases, the hacking may remain unnoticed, and become a long-term problem for the victim. Each instance of hacking can result in large losses for the victim, be they monetary, goodwill (public relations) or otherwise from the theft or destruction of private information. In order to eliminate the risks inherent in software security, a hardware security device is required.

It is an object of this invention to provide a hardware security device to allow interruption of a continuous data line.

It is a further object of this invention to provide a hardware security device which is suitable for either a single computer or a computer network of multiple computers.

It is a still further object of this invention to provide a hardware security device that is easily integrated into existing hardware and software.

### SUMMARY

The invention is a data interruption device which is comprised of an input port, an output port and a connection therebetween. The data interruption device provides for two states, one where the connection between the input port and output port is open, and the other where the connection is closed. A switch provides for the transition between the two states. The device also includes an external mechanism, preferably a push button, to activate the switch. The switch may also be controlled from a computer, if desired.

The input port and output port are connected to a computer and to the Internet, respectively. Alternatively, the input port and output port are connected to a computer and to a Local Area Network (LAN), respectively.

Preferably, the data interruption device includes a display to indicate the state of the connection. The display may be composed of LEDs, an LED or any similar component capable of indicating the current operating state of the connection between the input port and output port. The device may optionally include a timing mechanism, to provide for automatic transition from one state to the other at designated times. Preferably, the settings for the timing mechanism can be adjusted by the user, through hardware such as DIP switches or by software controlled from a computer connected to the input port.

The device may additionally include local security protection, such as a fingerprint sensor or retinal scanner, to prevent unauthorized local activation of the switch.

### BRIEF DESCRIPTION OF THE DRAWINGS

The invention itself both as to organization and method of operation, as well as additional objects and advantages thereof, will become readily apparent from the following detailed description when read in connection with the accompanying drawings:

FIG. 1 is a flow chart showing a conventional computer connection to the Internet;

FIG. 2 is a flow chart showing a computer connection to the Internet with a data interruption device;

FIG. 3 is a front view of a data interruption device;

FIG. 4 is a back view of a data interruption device;

FIG. 5 is a top view of a data interruption device;

FIG. 6 is a block diagram of the data interruption device;

FIG. 7 is a flow chart showing the logic used by an autotimer; and

FIG. 8 is a flow chart showing the logic used by a default timer.

### DETAILED DESCRIPTION

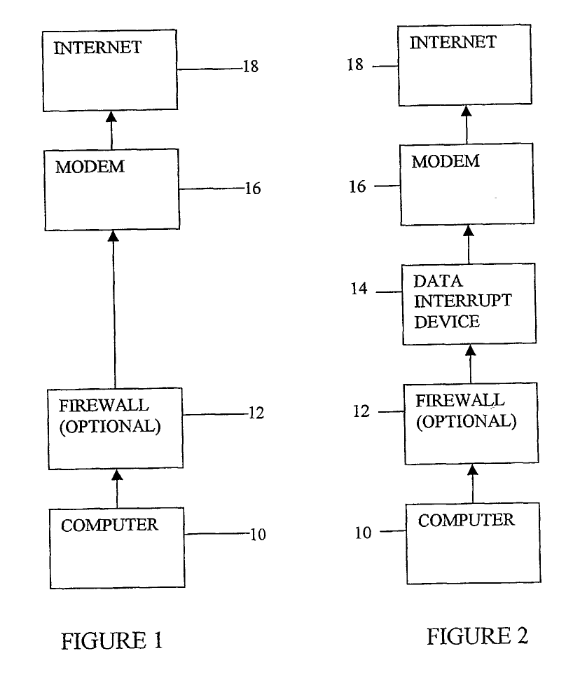

FIG. 1 shows a conventional connection from a computer 10 to the Internet 18. The computer 10 gains access to the Internet 18 through a modem 16. The connection between the computer 10 and the Internet 18 usually passes through a software firewall 12, to inhibit unauthorized access to the computer 10. For the purposes of this specification, the connection between the computer 10 and the Internet 18 is assumed to be a continuous, uninterrupted connection, such as a DSL/ADSL or cable modem connection. The description is equally applicable to other types of connections, such as dial-up (non-continuous) Internet connections or Local Area Network (LAN) connections.

In FIG. 2, a data interruption device 14 is inserted between the firewall 12 and the modem 16 or between the computer 10 and the modem 16 if a firewall is not present. Alternatively, the data interruption device 14 may be located between the modem 16 and the Internet 18. The data interruption device 14 acts as a switch to allow the otherwise uninterrupted connection between the computer 10 and the Internet 18 to be opened or closed.

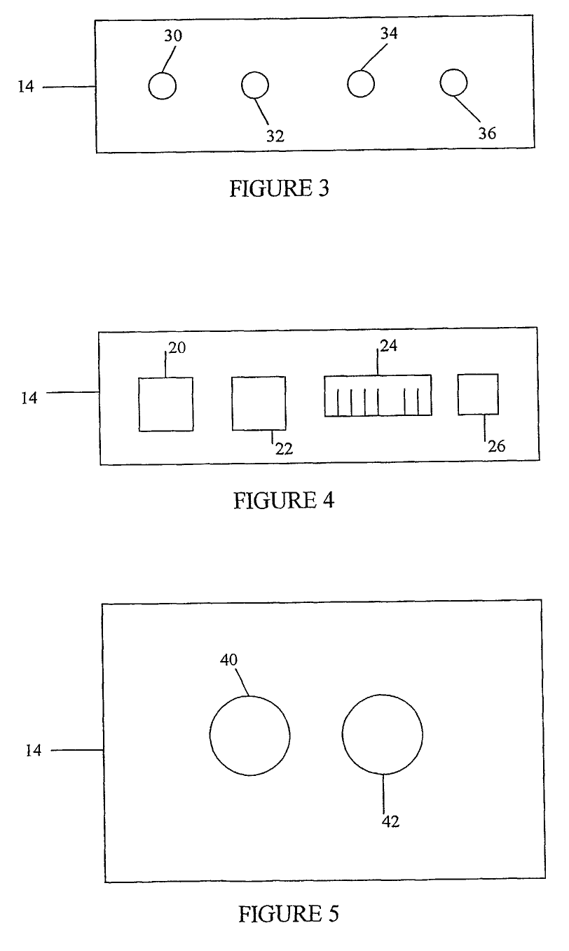

FIGS. 3, 4 and 5 show a physical embodiment of the data interruption device 14. FIG. 3 is a front view showing status indicators 30, 32, 34 and 36. As shown, the indicators 30, 32, 34 and 36 are LEDs, however any suitable data display method may be used. In FIG. 3, LED 30 is a power indicator and is lit when the device 14 is powered on and not lit when the data interruption device 14 is powered off. LED 32 is a connection indicator and is lit when the connection is open and is not lit when the connection is closed. LED 34 is a reset indicator and flashes when the timers are reset. LED 36 is an automatic monitoring indicator and is lit when the data interruption device 14 is in automatic monitoring mode (described below), and is not lit when the data interruption device 14 is not in automatic monitoring mode. Therefore, during normal operation with an open connection, LEDs 30, 32 and 36 will be lit, and LED 34 will be lit only when the connection is reset as discussed below.

The connection will be closed when the data interruption device 14 is powered off. Closing the connection adds increased security to the system. However, if desired, the data interruption device 14 may be configured such that the connection remains open when the data interruption device 14 is powered off.

FIG. 4 shows the rear of the data interruption device 14. There is a input port 20 and a output port 22. The exact nature of the input port 20 and the output port 22 will depend on the overall system and the type of connection. Some currently used examples include Category 5, Modular and 75-Ohm coaxial cables or wire. A series of DIP switches 24 allows for user adjustment of automatic timer settings. An AC power adaptor slot 26 for connecting an AC power supply (not shown) is also provided.

FIG. 5 is a top view of the data interruption device 14, showing a reset button 40 and activation button 42. The operation of the buttons 40 and 42 is discussed in more detail below.

The physical embodiment described in FIGS. 3,4 and 5 is meant to facilitate the description of the operation of the data interruption device 14. Obviously, the location of any of the described elements can be adjusted to any desired geometry. Furthermore, most of the described elements are easily replaceable or optional. For example, the LEDs 30, 32, 34 and 36 may be replaced by an alphanumeric LCD display. The push buttons 40 and 42 may be replaced by on/off switches and increased or decreased in number, depending on the desired functions of the data interruption device 14.

While the data interruption device 14 is described as a stand-alone external device, it may also be integrated into the computer 10 or the modem 16 to reduce cost and space requirements.

Additional elements can be included to enhance the capabilities of the data interruption device 14 as well. For example, a security system may be included to prevent unauthorized use of the reset button 40 and the activation button 42. This security system can take any desired form, such as a numeric keypad and PIN code, a magnetic card reader, a fingerprint scanner or a retinal scanner.

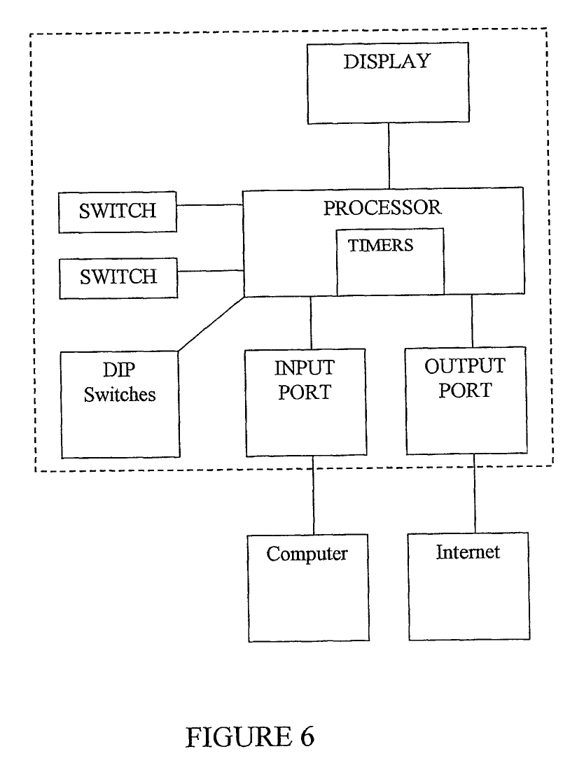

The block diagram in FIG. 6 reflects the overall functioning of the data interruption device 14. The input port 20 and output port 22 are connected to a processor 50. The functions of the processor 50 are reported in the display 52. The processor includes one or more timers 54, whose functions are described below.

Other elements are connected to the processor 50. These other elements can include DIP switches 24 for programming the processor, operating switches such as push buttons 40 and 42, or other desired features, such as input from a security system as described above.

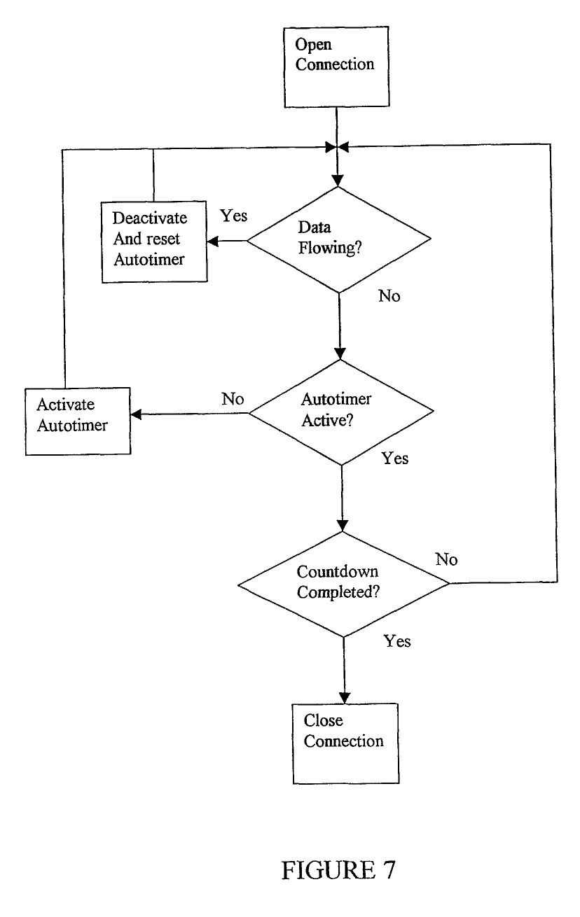

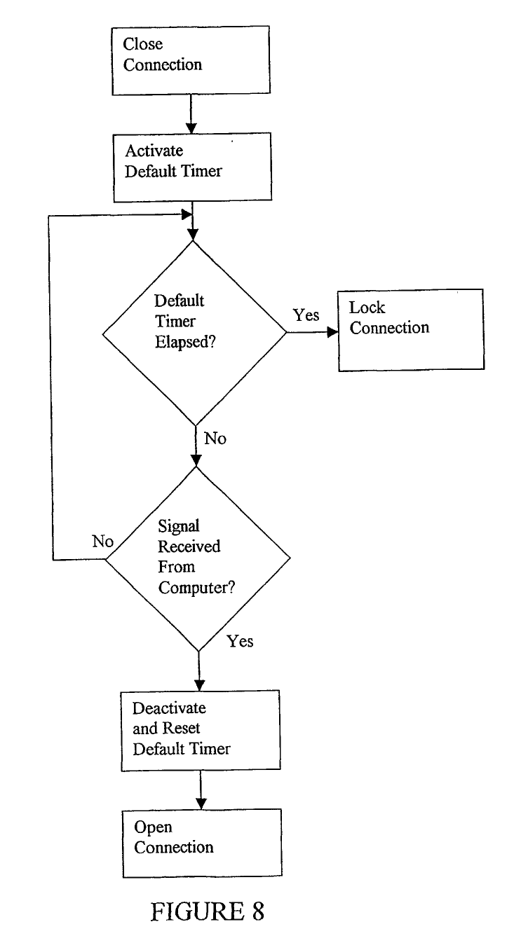

The data interruption device 14 functions in two modes. The first is an automatic monitoring mode. In this mode, the connection between the computer 10 and the Internet 18 is monitored for activity as shown by the flowcharts in FIGS. 7 and 8. Automatic monitoring mode is manually activated and deactivated by using push buttons 40 and 42 in combination. For example, automatic monitoring mode can be activated by pressing push buttons 40 and 42 simultaneously and deactivated by holding down the reset button 40 for 5 seconds. Alternatives using elements other than push buttons will use similar distinctive methods of activation and deactivation. When automatic monitoring mode is active, LED 36 will be lit.

Referring to FIG. 7, the open connection is monitored for activity at step 100. At step 102 the processor 50 (see FIG. 6) determines if data is flowing between the input port 20 (see FIG. 6) and the output port 22 (see FIG. 6). If data is flowing, then the autotimer is deactivated and reset (step 110) and the process returns to step 102. If data is not flowing, then the processor determines if the autotimer is active (step 104). If the autotimer is inactive, then the autotimer is activated (step 112) and the process returns to step 102. If the autotimer is active, then the processor determines if the autotimer countdown has been completed (step 106). If the autotimer countdown is not complete, the process returns to step 102. If the autotimer countdown is completed, then the connection between the input port 20 (see FIG. 6) and the output port 22 (see FIG. 6) is closed at step 108.

Referring to FIG. 8, when the connection is closed (step 108), a second timer, referred to as the default timer, is activated in step 114. The default timer has a substantially longer period than the autotimer. In step 116, the processor 50 (see FIG. 6) determines if the default timer has elapsed. If the default timer has elapsed, then the connection between the input port 20 (see FIG. 6) and the output port 22 (see FIG. 6) is locked (step 122) and can only be reopened by pushing the activation button 42 (see FIG. 6). Attempts to reopen the connection from the computer 10 (see FIG. 6) will no longer work.

If the default timer has not elapsed, the processor 50 then determines if a signal has been received from the computer 10 (step 118) as described below. If a signal has not been received, the process returns to step 116. If a signal is received, the processor deactivates and resets the default timer (step 120). The connection between the input port 20 and the output port 22 is then opened and the processor returns to step 100.

As described above, once the connection between the input port 20 and the output port 22 is closed with the data interruption device 14 in automatic monitoring mode, the user may open the connection and reset the default timer by sending a signal from the computer 10. The method of opening the connection between the input port 20 and the output port 22 is typically determined by software installed on the computer 10 and designed to operate in tandem with the data interruption device 14. Any desired method of sending a signal may be used, for example, by moving the mouse.

Preferably, the data interruption device 14 includes the option for the user to configure the values used by the autotimer and the default timer. As shown in FIG. 4, DIP switches 24 are used to adjust the timers to different preset values. Other methods, such as programming the values from the computer 10, can also be used.

The second method of using the data interruption device 14 is in a manual mode. This mode can be used in conjunction with the automatic monitoring mode described previously or can be used exclusively. In either case, activation button 42 is used to manually open and close the connection between the input port 20 and the output port 22, thereby opening and closing the connection between the computer 10 and the Internet 18. If the activation button 42 is used to close the connection, it can only be reopened in the same manner. Activation button 42 can also be held down for 5 seconds to deactivate the data interruption device 14 completely. The data interruption device 14 may then be reactivated by pushing buttons 40 and 42 either individually or simultaneously.

Additional features and components may be added to the data interruption device 14 without compromising its primary purpose. For example, a device with multiple input and output ports can be used in network applications, so that a single device can treat each computer in the network separately. Alternatively, the data interruption device 14 may be implemented as part of a network hub. Another variant of the device can provide a separate data output port from the CPU, to allow for extended monitoring of connection use in order to calculate optimal autotimer and default timer settings. The data interruption device 14 is intended to function with existing and future network and Internet devices to maximize both productivity and security.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the scope of the invention.

I claim:

1. A device comprising an input port, an output port and a switch wherein said switch is operative to open and close the connection between said input port and said output port and wherein one of said input port and said output port is connected to a computer and the other of said input port and said output port is connected to the Internet.

2. The device according to claim 1, wherein one of said input port and said output port is connected to a computer and the other of said input port and said output port is connected to a Local Area Network (LAN).

3. The device according to claim 1, wherein said switch is operated by a push button.

4. The device according to claim 1, wherein said switch can be operated from said computer.

5. The device according to claim 1, including a display operative to indicate the status of said connection.

6. The device according to claim 1, including a timing mechanism operative to automatically activate said switch and close said connection after a set time period of inactivity in said connection.

7. The device according to claim 6, wherein said device includes one or more DIP switches operative to set and modify said time periods of said timing mechanism.

8. The device according to claim 6, wherein said time periods of said timing mechanism are set and modified by software on said computer.

9. The device according to claim 1, including a security system operative to control access to said device.

10. The device according to claim 9, wherein said security system includes a fingerprint scanning device.

11. A method of interrupting a connection between an input port and an output port, said method comprising:
a) inserting a switch into said connection;
b) monitoring data flow activity within said connection;
c) activating a timer when said connection becomes inactive;
d) closing said switch when said timer reaches a preset value, thereby closing said connection; and
e) deactivating said timer when said connection becomes active and said timer has not reached said preset value;
wherein one of said input port and said output port is connected to a computer and the other of said input port and said output port is connected to the Internet.

12. The method according to claim 11, additionally including:
a) activating a second timer when said connection is closed;
b) locking said connection in a closed state, such that said switch cannot be opened by a signal from said computer, when said second timer reaches a second preset value; and
c) opening said connection when a signal is received from said computer and said second timer has not reached said second preset value.

13. The method according to claim 12, wherein said switch can be opened or closed by an external mechanism operating independently of said timer and said second timer.

14. The method according to claim 11, wherein one of said input port and said output port is connected to a computer and the other of said input port or said output port is connected to a Local Area Network (LAN).
